(19) United States
(12) Patent Application Publication
(10) Pub. No.: US 2023/0256988 A1
(43) Pub. Date: Aug. 17, 2023

(54) DYNAMIC LIDAR ADJUSTMENTS BASED ON AV ROAD CONDITIONS

(71) Applicant: GM Cruise Holdings LLC, SAN FRANCISCO, CA (US)

(72) Inventor: Sandeep Gangundi, San Jose, CA (US)

(21) Appl. No.: 17/674,168

(22) Filed: Feb. 17, 2022

(51) Int. Cl. B60W 60/00; G01C 21/34; G06F 8/71

(52) U.S. Cl. CPC B60W 60/001; G01C 21/3438; G06F 8/71; B60W 2420/52; B60W 2554/4048

(57) ABSTRACT

Methods and systems are provided for dynamically adjusting at least one setting of a lidar. In some aspects, a process can include steps for receiving, at an autonomous vehicle system, road condition data associated with an autonomous vehicle, generating, by the autonomous vehicle system, instructions to adjust the at least one setting of the lidar of the autonomous vehicle based on the road condition data, and providing, by the autonomous vehicle system, the instructions to adjust the at least one setting of the lidar to the lidar, the instructions including updating firmware of the lidar to adjust the at least one setting of the lidar.

### BACKGROUND

### 1. Technical Field

The subject technology provides solutions for autonomous vehicle systems, and in particular, for providing dynamic lidar adjustments based on autonomous vehicle road conditions.

### 2. Introduction

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide safe and efficient transportation. Such tasks may require the collection and processing of large quantities of data disposed on the autonomous vehicle.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example of a system for managing one or more Autonomous Vehicles (AVs), according to some aspects of the disclosed technology.

FIG. 2 illustrates an example system used for training a machine-learning (ML) model to perform semantic labeling, according to some aspects of the disclosed technology.

FIG. 3 illustrates an example block diagram of a semantic labeling system, according to some aspects of the disclosed technology.

FIG. 4 illustrates an example process of dynamic lidar adjustment, according to some aspects of the disclosed technology.

FIG. 5 illustrates an example process of dynamically adjusting a setting of a lidar, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

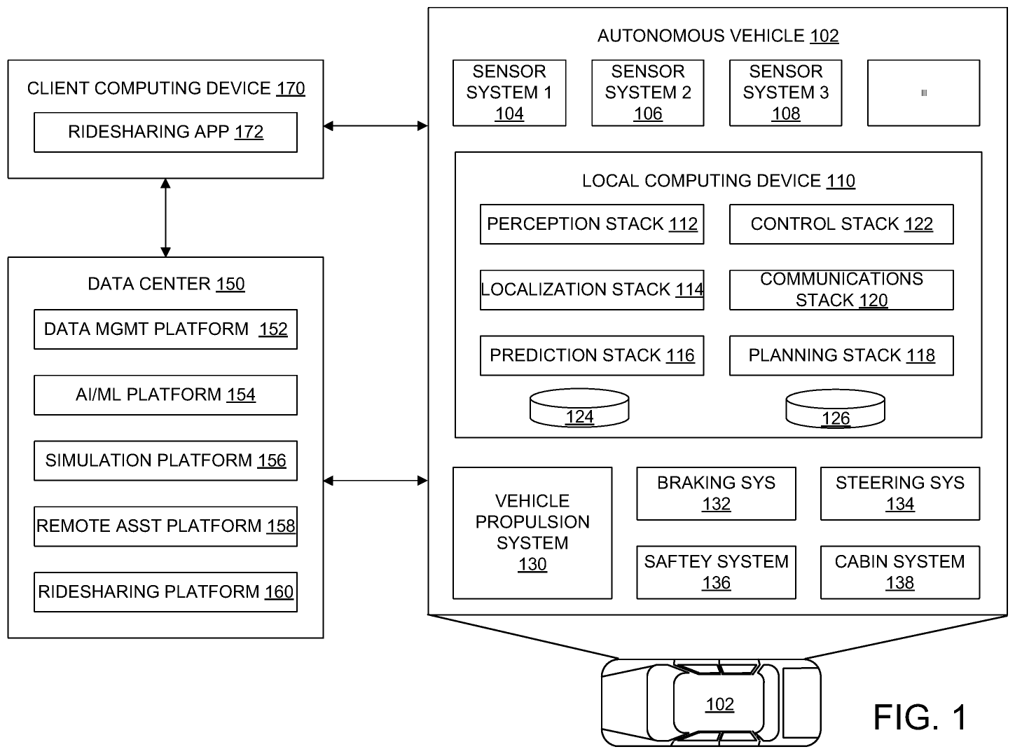

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

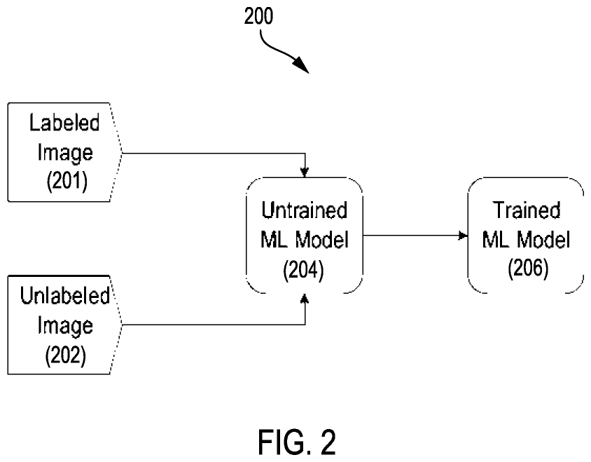

FIG. 2 illustrates an example system 200 used for training a machine-learning (ML) model to perform bounding box labeling (geometric labeling) and semantic labeling, according to some aspects of the technology. As illustrated in system 200, examples of labeled images 201 and unlabeled images 202 are provided to untrained ML model 204. Untrained ML model 204 can include one or more general adversarial networks (GANs), which are configured to learn labeling conventions based on labeled image examples (201). For instance, untrained ML model 204 can learn how geometric bounding boxes (polygons) and semantic labels are to be associated with certain image features. In some aspects, bounding boxes can be colored based on the semantic association. For example, crosswalks can be bounded by yellow colored polygons, whereas intersections may be bounded by red polygons, etc. In other implementations, semantic labels such as metadata word tags can be associated with bounding boxes around salient image features, or associated with the image features directly.

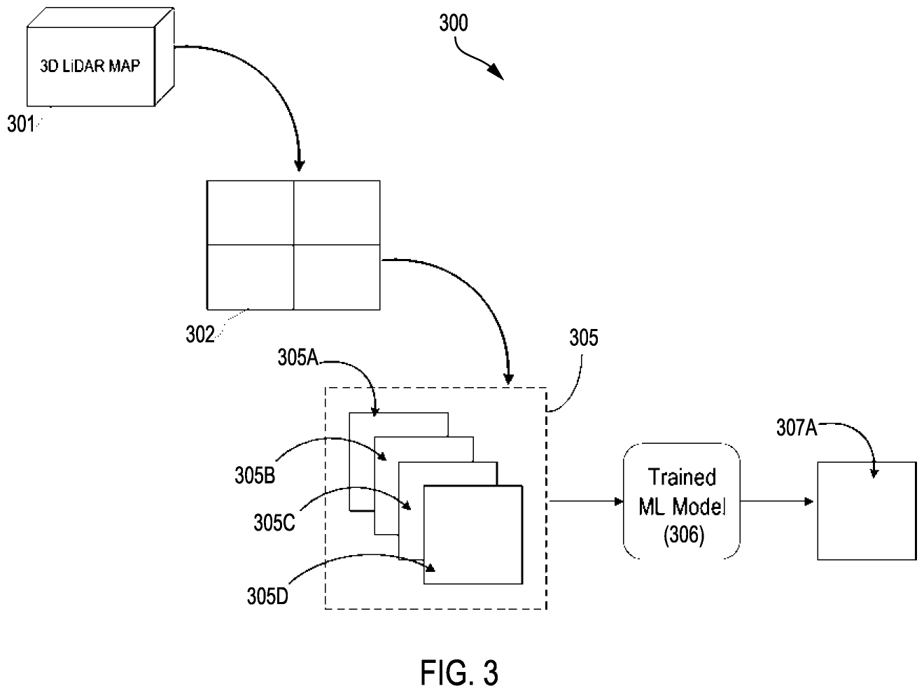

FIG. 3 illustrates a conceptual block diagram of a semantic labeling system 300, according to some aspects of the technology. In system 300, a LiDAR map (e.g., a high-resolution 3D map) 301 is first converted into a two-dimensional (2D) map 302, for example, using an inverse perspective mapping process or other dimensional reduction technique. The 2D LiDAR map 302 is then segmented (e.g., rasterized) into a plurality of image segments or tiles 305 (e.g., tiles 305A, 305B, 305C, and 305D). Each tile is then provided to a trained ML labeling model, such as trained ML model 306. Segmentation of the 2D LiDAR map can improve label processing by reducing the size of input data provided to ML model 306. Tiling can also facilitate parallel processing, for example, utilizing multiple labeling models (not shown) in a parallel processing architecture.

The outputs of ML model 306 are labeled image tiles. For example, labeled tile 307A can represent a labeled image-to-image transformation resulting from processing performed on 2D LiDAR image input tile 305A. That is, labeled tile 307A can include one or more bounding boxes (polygons) that identify image features salient to AV navigation, such as, crosswalks, sidewalks, roadways, on-ramps, driveways, parking lots, parking spaces, bike-lanes, road-signs, and/or traffic lights, etc. As discussed above, bounding boxes can be associated with semantic labels. In some approaches, semantic labeling associations can be indicated by color coding, wherein bounding box color indicates the enclosed image feature. Alternatively (or additionally) semantic labeling can be performed using metadata tags, for example that provide a word-label for the associated image feature i.e., “crosswalk”, “intersection”, or “lane boundary”, etc.

Traditionally, settings for lidar and radar are static and configured for an autonomous vehicle at an initial setup of the autonomous vehicle. For example, when an autonomous vehicle is configured to join an autonomous vehicle fleet, pre-determined settings are configured into the autonomous vehicle. Currently, the autonomous vehicle is unable to change settings or parameters of the lidar at a firmware level. The firmware of the autonomous vehicle is “flashed” with settings, and no changes are able to be made thereafter. This, in turn, impacts an ability to improve lidar performance of the autonomous vehicle because of rigid firmware requirements. For example, continuous 360 degree field-of-view (FOV) and scan patterns exert a large amount of processing power, while the frequency utilized by the lidar may not be the most optimal frequency for the situation, all of which are inefficient usages of available resources.

As such, a need exists to dynamically adjust the firmware of a lidar to provide improvements to lidar performance. The present disclosure can provide continuous usage of dense lidar and designate regions of interest to save time and computation power of the system of the autonomous vehicle.

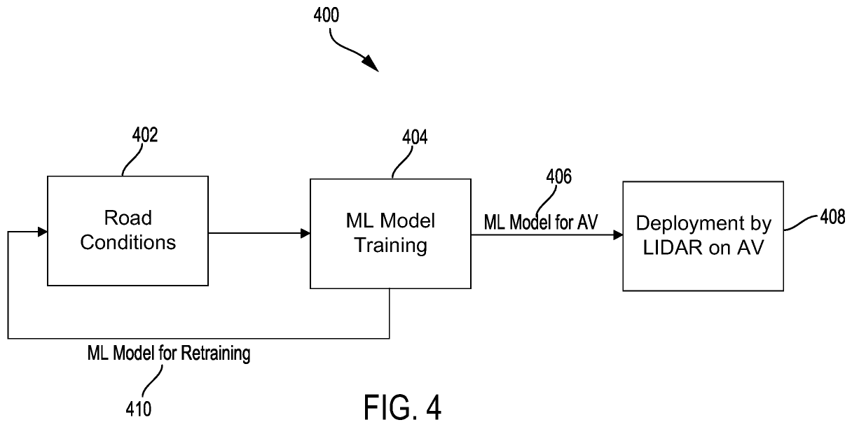

FIG. 4 illustrates an example process of dynamic lidar adjustment 400, according to some aspects of the disclosed technology. In some implementations, the process 400 can include a step of receiving road condition data 402 from the local computing device 110 of the autonomous vehicle 102, the data center 150, and/or the client computing device 170 of FIG. 1. For example, the road condition data 402 can include a speed of the autonomous vehicle, road speed, road pitch, information relating to an upcoming autonomous vehicle maneuver, designated path of travel, predetermined autonomous vehicle route, location of the autonomous vehicle, or any other data suitable for the intended purpose and understood by a person of ordinary skill in the art.

In other implementations, the process 400 can include utilizing machine learning (ML) models 404, as described herein, to determine which parameters of the lidar of an autonomous vehicle to dynamically adjust accordingly. For example, after road condition data 402 is received by the process 400, step 404 can include training and utilizing ML models to determine which parameters of a lidar of the autonomous vehicle to adjust accordingly. In some examples, based on the road condition data 402, the process 400 can include adjusting a field-of-view (FOV), a scan pattern, a frequency, or any other parameter of the lidar that is suitable for the intended purpose and understood by a person of ordinary skill in the art. The adjustments to the firmware of the lidar of the autonomous vehicle can focus on regions-of-interest (ROI) while driving to focus on the areas that are more meaningful to perform an upcoming maneuver or to maintain a current autonomous vehicle behavior.

Regarding an FOV adjustment, if it is determined that the path of travel of the autonomous is to exit a freeway, the firmware of the lidar can be updated or revised to focus the FOV of the lidar in the direction of the freeway exit. In an example of the autonomous vehicle proceeding down a highway, the firmware of the lidar can be updated or revised to focus the FOV of the lidar in a forward direction of the autonomous vehicle because more concerning areas of travel are typically in front of the autonomous vehicle when driving down a highway.

Regarding a scan pattern, the density/resolution of the scan pattern of the lidar of the autonomous vehicle can be adjusted in response to the road conditions 402. As in the example above, if the autonomous vehicle is traveling along a highway, the ROI is in a forward direction of the autonomous vehicle. The firmware of the lidar can be updated to adjust the density/resolution of the scan pattern of the lidar to be more dense, which will then provide more data within the ROI (e.g., forward-facing FOV). The number of lidar points of the scan pattern can also be dynamically adjusted by the process 400.

Regarding the frequency, lidars typically operate at 10 Hz. The process 400 of the present disclosure can update the frequency utilized by the lidar by updating the firmware of the lidar to an operating frequency range of 15-25 Hz (e.g., 20 Hz), depending on the road conditions 402. For example, if the autonomous vehicle is traveling along a highway at a fast pace of 70 MPH, the higher frequency of 20 Hz allows the autonomous vehicle to obtain more data within the ROI of the lidar.

In some implementations, the pitch or angle of the lidar can be adjusted by the process 400 based on the road condition data 402. For example, if the road condition data 402 includes information that there is an upcoming hill along the designated route of the autonomous vehicle, the process 400 can update the firmware of the lidar to adjust the pitch angle of the lidar to a more upwardly angle to account for the upcoming hill along the designated route.

The process 400 can further include providing selected or determined ML models 406 to the autonomous vehicle 408 to be deployed accordingly. For example, based on the road conditions 402 and the ML models 404, the autonomous vehicle can utilize the ML model 406 selected by the process 400 to update the firmware of the lidar of the autonomous vehicle. The firmware of the lidar of the autonomous vehicle has be flashed by the autonomous vehicle based on the process 400 to dynamically adjust parameters of the lidar as described herein.

In some implementations, the process 400 can also include utilizing the selected or determined ML models from step 404 to further retrain the ML models 410 utilized by the process 400 to improve the ML model selection process.

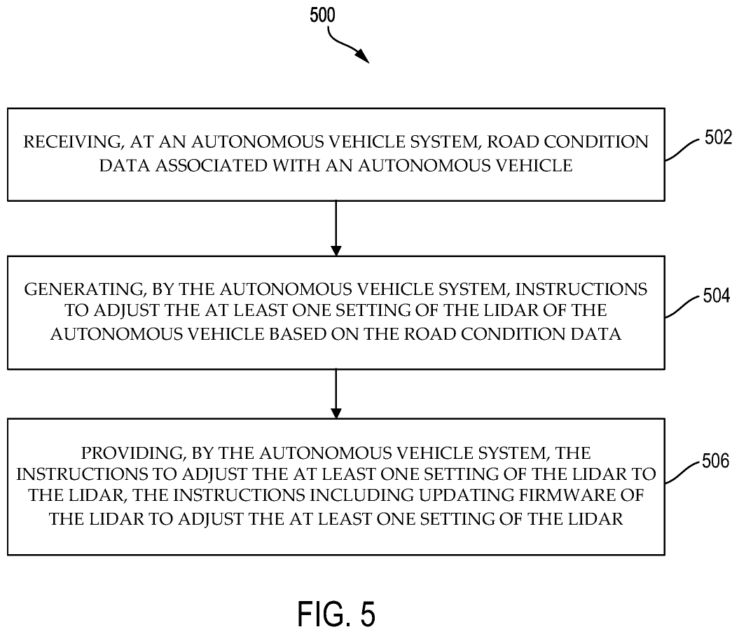

Having disclosed some example system components and concepts, the disclosure now turns to FIG. 5, which illustrates an example method 500 for dynamically adjusting at least one setting of a lidar. The steps outlined herein are exemplary and can be implemented in any combination thereof, including combinations that exclude, add, or modify certain steps.

At step 502, method 500 can include receiving, at an autonomous vehicle system, road condition data associated with an autonomous vehicle.

At step 504, method 500 can include generating, by the autonomous vehicle system, instructions to adjust the at least one setting of the lidar of the autonomous vehicle based on the road condition data.

At step 506, method 500 can include providing, by the autonomous vehicle system, the instructions to adjust the at least one setting of the lidar to the lidar, the instructions including updating firmware of the lidar to adjust the at least one setting of the lidar.

In some implementations, the road condition data can include a speed of the autonomous vehicle. The at least one setting of the lidar can include a field-of-view of the lidar, the firmware of the lidar being adjusted to update the field-of-view of the lidar based on the speed of the autonomous vehicle.

In other implementations, the road condition data can include a pitch of a segment of a route of the autonomous vehicle. The at least one setting of the lidar can include a pitch angle of the lidar, the firmware of the lidar being adjusted to update the pitch angle of the lidar based on the pitch of the segment of the route of the autonomous vehicle.

In some examples, the road condition data can include an upcoming maneuver to be performed by the autonomous vehicle. The at least one setting of the lidar can include an operating frequency of the lidar, the firmware of the lidar being adjusted to update the operating frequency of the lidar based on the upcoming maneuver to be performed by the autonomous vehicle.

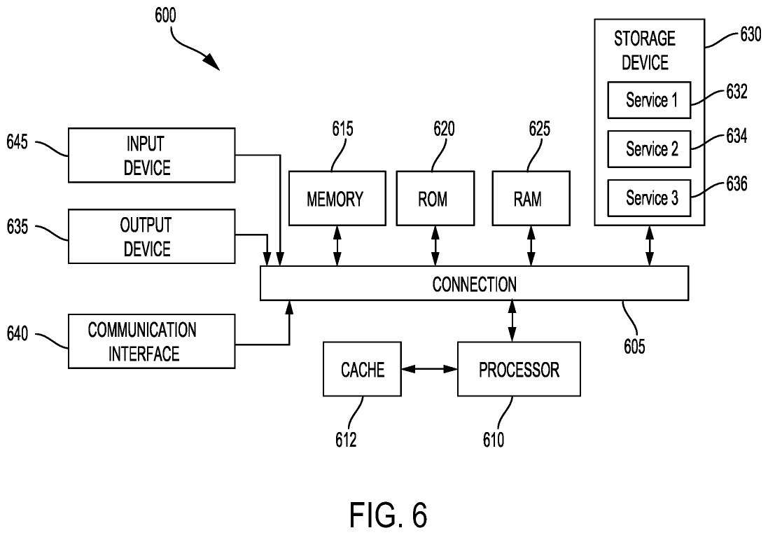

FIG. 6 illustrates an example processor-based system with which some aspects of the subject technology can be implemented. For example, processor-based system 600 that can be any computing device making up local computing device 110, data center 150, client computing device 170, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. By way of example computer-executable instructions can be used to implement perception system functionality for determining when sensor cleaning operations are needed or should begin. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method for dynamically adjusting at least one setting of a lidar, the computer-implemented method comprising:
receiving, at an autonomous vehicle system, road condition data associated with an autonomous vehicle;
generating, by the autonomous vehicle system, instructions to adjust the at least one setting of the lidar of the autonomous vehicle based on the road condition data; and
providing, by the autonomous vehicle system, the instructions to adjust the at least one setting of the lidar to the lidar, the instructions including updating firmware of the lidar to adjust the at least one setting of the lidar.

2. The computer-implemented method of claim 1, wherein the road condition data includes a speed of the autonomous vehicle.

3. The computer-implemented method of claim 2, wherein the at least one setting of the lidar includes a field-of-view of the lidar, the firmware of the lidar being adjusted to update the field-of-view of the lidar based on the speed of the autonomous vehicle.

4. The computer-implemented method of claim 1, wherein the road condition data includes a pitch of a segment of a route of the autonomous vehicle.

5. The computer-implemented method of claim 4, wherein the at least one setting of the lidar includes a pitch angle of the lidar, the firmware of the lidar being adjusted to update the pitch angle of the lidar based on the pitch of the segment of the route of the autonomous vehicle.

6. The computer-implemented method of claim 1, wherein the road condition data includes an upcoming maneuver to be performed by the autonomous vehicle.

7. The computer-implemented method of claim 6, wherein the at least one setting of the lidar includes an operating frequency of the lidar, the firmware of the lidar being adjusted to update the operating frequency of the lidar based on the upcoming maneuver to be performed by the autonomous vehicle.

8. A system for dynamically adjusting at least one setting of a lidar, the system comprising:
one or more processors; and
at least one computer-readable storage medium having stored therein instructions which, when executed by the one or more processors, cause the system to:
receive road condition data associated with an autonomous vehicle;
generate instructions to adjust the at least one setting of the lidar of the autonomous vehicle based on the road condition data; and
provide the instructions to adjust the at least one setting of the lidar to the lidar, the instructions including updating firmware of the lidar to adjust the at least one setting of the lidar.

9. The system of claim 8, wherein the road condition data includes a speed of the autonomous vehicle.

10. The system of claim 9, wherein the at least one setting of the lidar includes a field-of-view of the lidar, the firmware of the lidar being adjusted to update the field-of-view of the lidar based on the speed of the autonomous vehicle.

11. The system of claim 8, wherein the road condition data includes a pitch of a segment of a route of the autonomous vehicle.

12. The system of claim 11, wherein the at least one setting of the lidar includes a pitch angle of the lidar, the firmware of the lidar being adjusted to update the pitch angle of the lidar based on the pitch of the segment of the route of the autonomous vehicle.

13. The system of claim 8, wherein the road condition data includes an upcoming maneuver to be performed by the autonomous vehicle.

14. The system of claim 13, wherein the at least one setting of the lidar includes an operating frequency of the lidar, the firmware of the lidar being adjusted to update the operating frequency of the lidar based on the upcoming maneuver to be performed by the autonomous vehicle.

15. A non-transitory computer-readable storage medium comprising:
instructions stored on the non-transitory computer-readable storage medium, the instructions, when executed by one or more processors, cause the one or more processors to:
receive road condition data associated with an autonomous vehicle;
generate instructions to adjust at least one setting of a lidar of the autonomous vehicle based on the road condition data; and
provide the instructions to adjust the at least one setting of the lidar to the lidar, the instructions including updating firmware of the lidar to adjust the at least one setting of the lidar.

16. The non-transitory computer-readable storage medium of claim 15, wherein the road condition data includes a speed of the autonomous vehicle.

17. The non-transitory computer-readable storage medium of claim 16, wherein the at least one setting of the lidar includes a field-of-view of the lidar, the firmware of the lidar being adjusted to update the field-of-view of the lidar based on the speed of the autonomous vehicle.

18. The non-transitory computer-readable storage medium of claim 15, wherein the road condition data includes a pitch of a segment of a route of the autonomous vehicle.

19. The non-transitory computer-readable storage medium of claim 18, wherein the at least one setting of the lidar includes a pitch angle of the lidar, the firmware of the lidar being adjusted to update the pitch angle of the lidar based on the pitch of the segment of the route of the autonomous vehicle.

20. The non-transitory computer-readable storage medium of claim 15, wherein the road condition data includes an upcoming maneuver to be performed by the autonomous vehicle, and wherein the at least one setting of the lidar includes an operating frequency of the lidar, the firmware of the lidar being adjusted to update the operating frequency of the lidar based on the upcoming maneuver to be performed by the autonomous vehicle.
